(19) United States
(12) Patent Application Publication
(10) Pub. No.: US 2017/0363017 A1
(43) Pub. Date: Dec. 21, 2017

(54) EXHAUST PURIFICATION APPARATUS FOR INTERNAL COMBUSTION ENGINE

(71) Applicant: DENSO CORPORATION, Kariya-city, Aichi-pref. (JP)

(72) Inventor: Shingo NAKATA, Kariya-city (JP)

(21) Appl. No.: 15/541,796

(22) PCT Filed: Feb. 5, 2016
(86) PCT No.: PCT/JP2016/000606

§ 371 Date: Jul. 6, 2017

(30) Foreign Application Priority Data
Feb. 18, 2015 (JP) 2015-029183

(51) Int. Cl. F02D 9/04; F01N 11/00; F01N 3/20; F02D 41/02; F02D 41/18; F02D 41/10

(52) U.S. Cl. CPC F02D 9/04; F02D 41/18; F02D 41/10; F01N 3/2006; F02D 41/0255; F01N 11/002; F01N 2560/07

(57) ABSTRACT

An exhaust purification apparatus for an internal combustion engine has an exhaust purification catalytic agent disposed in an exhaust passage. The exhaust purification apparatus for the internal combustion engine has an exhaust throttle valve, an actuator, and a controller. The exhaust throttle valve is arranged upstream of the exhaust purification catalytic agent in the exhaust passage and changes a passage sectional area of the exhaust passage. The actuator operates the exhaust throttle valve to be open and closed. The controller controls the exhaust throttle valve to be open and closed through the actuator. The controller decreases an opening degree of the exhaust throttle valve to narrow the passage sectional area of the exhaust passage upon a heating request for heating the exhaust purification catalytic agent.

### CROSS REFERENCE TO RELATED APPLICATION

This application is based on Japanese Patent Application No. 2015-029183 filed on Feb. 18, 2015, the disclosure of which is incorporated herein by reference.

### Technical Field

The present disclosure relates to an exhaust purification apparatus for an internal combustion engine, the exhaust purification apparatus having an exhaust catalytic agent disposed in an exhaust passage.

### Background Art

An exhaust purification catalytic agent for an internal combustion engine mounted in a vehicle or the like is disposed in an exhaust passage and reduces emissions included in exhaust gas. The exhaust purification catalytic agent generally exerts an exhaust purification performance when a temperature of the exhaust purification catalytic agent reaches a specified activation temperature. In other words, the exhaust purification catalytic agent cannot exert the exhaust purification performance sufficiently when the temperature of the exhaust purification catalytic agent is lower than the specified activation temperature.

Then, an exhaust purification apparatus described in Patent Literature 1 has a secondary air injection nozzle and a throttle valve. The secondary air injection nozzle is arranged upstream of an exhaust purification catalytic agent in an exhaust passage. The throttle valve is arranged downstream of the exhaust purification catalytic agent in the exhaust passage. The exhaust purification apparatus described in Patent Literature 1 activates the exhaust purification catalytic agent in a manner that the throttle valve is fully closed when a cooling operation for cooling an internal combustion engine is started and that an exhaust temperature is increased by supplying a secondary air from the secondary air injection nozzle. A temperature of the exhaust purification catalytic agent tends to be lower than an activation temperature during the cooling operation.

### PRIOR ART LITERATURES

### Patent Literature

Patent Literature 1: JP 2001-132436 A

### SUMMARY OF INVENTION

According to studies conducted by the inventor of the present disclosure, an exhaust pressure increases as time proceeds, not increases immediately, when the throttle valve is fully open, according to the exhaust purification apparatus described in Patent Literature 1. As a result, the exhaust temperature and the temperature of the exhaust purification catalytic agent also increase as time proceeds. Therefore, a certain amount of time is required for increasing the temperature of the exhaust purification catalytic agent to the activation temperature, and thereby is it difficult to activate the exhaust purification catalytic agent promptly.

The present disclosure addresses the above-described issues, and it is an objective of the present disclosure to provide an exhaust purification apparatus for an internal combustion engine that can secure a reduction effect reducing emissions and that can increase a temperature of an exhaust purification catalytic agent promptly.

An exhaust purification apparatus for an internal combustion engine has an exhaust purification catalytic agent disposed in an exhaust passage. The exhaust purification apparatus for the internal combustion engine has an exhaust throttle valve, an actuator, and a controller. The exhaust throttle valve is arranged upstream of the exhaust purification catalytic agent in the exhaust passage and changes a passage sectional area of the exhaust passage. The actuator operates the exhaust throttle valve to be open and closed. The controller controls the exhaust throttle valve to be open and closed through the actuator. The controller decreases an opening degree of the exhaust throttle valve to narrow the passage sectional area of the exhaust passage upon a heating request for heating the exhaust purification catalytic agent.

According to the above-described configuration, exhaust gas flows to a part of the exhaust purification catalytic agent locally when the exhaust throttle valve narrows the passage sectional area of the exhaust passage. As a result, a temperature of the part of the exhaust purification catalytic agent increases promptly, thereby the exhaust purification catalytic agent can be activated promptly. In addition, most of the exhaust gas flows in an activated portion of the exhaust purification catalytic agent, and thereby a reduction effect reducing emissions can be secured.

Thus, according to the present disclosure, a temperature of the exhaust purification catalytic agent can be increased more promptly while securing the reduction effect reducing emissions.

### BRIEF DESCRIPTION OF DRAWINGS

The above and other objects, features and advantages of the present disclosure will become more apparent from the following detailed description made with reference to the accompanying drawings.

FIG. 1 is a diagram illustrating a schematic configuration of an exhaust purification apparatus for an internal combustion engine according to an embodiment.

FIG. 2 is a cross-sectional view illustrating a peripheral structure of an exhaust purification catalytic agent according to the embodiment.

FIG. 3 is a flow chart illustrating a proceeding of a control for opening and closing an exhaust throttle valve operated by the exhaust purification apparatus.

FIG. 4 is a graph showing a flow speed distribution of exhaust gas flowing in an exhaust passage.

FIG. 5A is a graph showing a temperature variation in the exhaust purification catalytic agent without the exhaust throttle valve.

FIG. 5B is a graph showing a temperature variation in the exhaust purification catalytic agent when the exhaust throttle valve narrows a passage sectional area of the exhaust passage.

FIG. 5C is a graph showing a temperature variation in the exhaust purification catalytic agent when the exhaust throttle valve further narrows the passage sectional area of the exhaust passage.

FIG. 6A is a graph showing a temperature variation in the exhaust purification catalytic agent without the exhaust throttle valve 33.

FIG. 6B is a graph showing a temperature variation in the exhaust purification catalytic agent when the exhaust throttle valve narrows a passage sectional area of the exhaust passage.

FIG. 6C is a graph showing a temperature variation in the exhaust purification catalytic agent when the exhaust throttle valve further narrows the passage sectional area of the exhaust passage.

FIG. 7 is a flow chart illustrating a proceeding of a control for opening and closing an exhaust throttle valve according to an another embodiment of the present disclosure.

FIG. 8 is a flow chart illustrating a proceeding of a control for opening and closing an exhaust throttle valve according to an another embodiment of the present disclosure.

### DESCRIPTION OF EMBODIMENTS

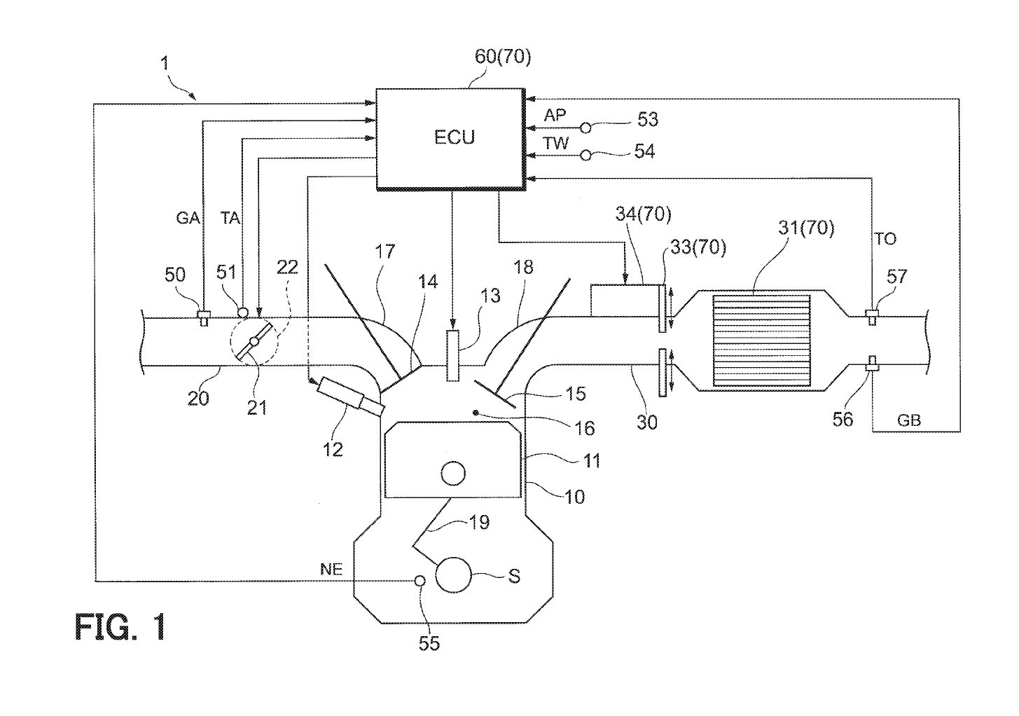

An embodiment of an exhaust purification apparatus for an internal combustion engine will be described hereafter. The internal combustion engine of the present embodiment is a cylindrical injection engine. FIG. 1 is a diagram illustrating a schematic configuration of the internal combustion engine of the present embodiment around a single cylinder.

As shown in FIG. 1, an internal combustion engine 1 of the present embodiment has a cylinder 10, a piston 11, a fuel injection valve 12, a spark plug 13, an intake valve 14, and an exhaust valve 15.

The piston 11 is housed in the cylinder 10 to reciprocate in the cylinder 10. A space surrounded by the cylinder 10 and the piston 11 defines a combustion chamber 16.

The fuel injection valve 12 is arranged to protrude into the combustion chamber 16. A high-pressure fuel is supplied to the fuel injection valve 12 through a common rail (not shown). The fuel injection valve 12 injects the fuel into the combustion chamber 16. The combustion chamber 16 is connected to an intake passage 20 through an intake port 17 provided in the cylinder 10. The combustion chamber 16 is also connected to an exhaust passage 30 through an exhaust port 18 provided in the cylinder 10.

The spark plug 13 is arranged to protrude into the combustion chamber 16. The spark plug 13 ignites the fuel in the combustion chamber 16 when electrical power is applied to the spark plug 13.

In the combustion chamber 16, intake air introduced through the intake passage 20 and the intake port 17 and the fuel injected by the fuel injection valve 12 are mixed to be a mixed gas. The mixed gas generated in the combustion chamber 16 is combusted due to an ignition by the spark plug 13. The piston 11 reciprocates in the cylinder 10 due to the combustion of the mixed gas. The reciprocation of the piston 11 is converted to a rotational movement of an engine output shaft S through a connecting rod 19, thereby generating a power as the internal combustion engine. Exhaust gas generated by the combustion of the mixed gas is emitted through the exhaust port 18 and the exhaust passage 30.

The intake valve 14 is arranged in the intake port 17. The intake valve 14 opens and closes the intake port 17.

The exhaust valve 15 is arranged in the exhaust port 18. The exhaust valve 15 opens and closes the exhaust port 18.

The internal combustion engine 1 has a throttle valve 21, a throttle motor 22, an intake air volume sensor 50, and a throttle opening degree sensor 51 that are disposed in the intake passage 20. The throttle valve 21 adjusts a volume of intake air introduced into the combustion chamber 16 by changing a passage sectional area of the intake passage 20. The throttle motor 22 operates the throttle valve 21 to be open and closed. The intake air volume sensor 50 detects an intake air volume GA of the intake air introduced into the combustion chamber 16. The throttle opening degree sensor 51 detects a throttle opening degree TA that is an opening degree of the throttle valve 21.

The internal combustion engine 1 has an exhaust purification catalytic agent 31, an exhaust throttle valve 33, and an actuator 34 that are disposed in the exhaust passage 30.

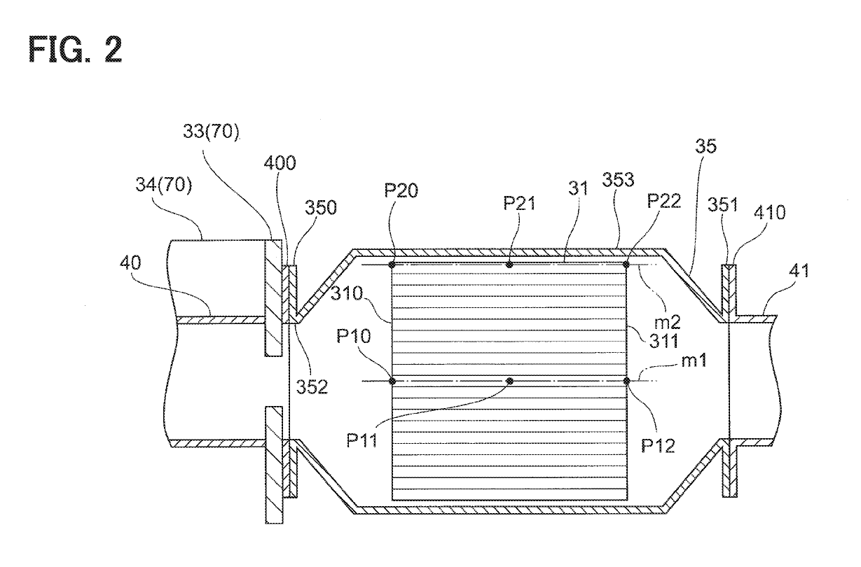

As shown in FIG. 2, the exhaust purification catalytic agent 31 is housed in a case 35 that configures a part of the exhaust passage 30. The case 35 surrounds the exhaust purification catalytic agent 31. The case 35 has a flange 350 and a flange 351 at both ends respectively. The flange 350 is fixed to a flange 400 of an upstream exhaust pipe 40 by a method such as bolting (not shown). The upstream exhaust pipe 40 is connected to the exhaust port 18 through an exhaust manifold (not shown). The flange 351 is fixed to a flange 410 of a downstream exhaust pipe 41 by a method such as bolting (not shown). In the following description, an opening portion of the flange 350, which is an inlet of the case 35 from which the exhaust gas flows in, will be referred to as an exhaust inlet port 352.

The case 35 has a large diameter portion 353 that enlarges a passage sectional area of the case 35. The large diameter portion 353 is located in a center area of the case 35. The exhaust purification catalytic agent 31 is housed in the large diameter portion 353. The exhaust purification catalytic agent 31 may be a three-way catalytic agent. The exhaust purification catalytic agent 31 purifies the exhaust gas by oxidizing and reducing a toxic substance such as hydrocarbon, carbon monoxide, and nitrogen oxide included in the exhaust gas.

The exhaust throttle valve 33 is arranged adjacent to the exhaust inlet port 352 of the case 35. That is, the exhaust throttle valve 33 is located upstream of the exhaust purification catalytic agent 31. The exhaust throttle valve 33 changes a passage sectional area of the exhaust passage 30 by reciprocating between a closing position shown in the drawings and an opening position at which the exhaust throttle valve 33 fully opens the exhaust passage 30. The closing position shown in the drawings is a position at which the exhaust throttle valve 33 narrows the passage sectional area of the exhaust passage 30 to define a single throttle path in a center area of the exhaust passage 30.

The actuator 34 may be configured centering around a motor. The actuator 34 operates the exhaust throttle valve 33 to reciprocate between the closing position and the opening position.

As shown in FIG. 1, the internal combustion engine 1 has an accelerator opening degree sensor 53, a water temperature sensor 54, and an engine rotational speed sensor 55. The accelerator opening degree sensor 53 detects an accelerator displacement amount AP that is an displacement amount of an accelerator of a vehicle when being pressed to the floor. The water temperature sensor 54 detects a cooling water temperature TW that is a temperature of cooling water cooling the internal combustion engine 1. The engine rotational speed sensor 55 detects an engine rotational speed NE that is a rotational speed of the engine output shaft S.

The internal combustion engine 1 has an ECU (Electronic Control Unit) 60 as a controller that controls the fuel injection valve 12, the spark plug 13, the throttle motor 22, and the actuator 34. The ECU 60 is configured centering around a microcomputer and has CPU and a memory. Output signals from the intake air volume sensor 50, the throttle opening degree sensor 51, the accelerator opening degree sensor 53, the water temperature sensor 54, and the engine rotational speed sensor 55 are input to the ECU 60. The ECU 60 obtains information regarding the intake air volume GA, the throttle opening degree TA, the acceleration displacement amount AP, the cooling water temperature TW, and the engine rotational speed sensor NE with a specified period based on the output signals from the sensors 50 to 55.

The ECU 60 controls a fuel injection timing, a fuel injection volume, and the throttle opening degree TA by controlling the fuel injection valve 12, the spark plug 13, and the throttle motor 22 based on the intake air volume GA, the throttle opening degree TA, the acceleration displacement amount AP, and the engine rotational speed NE.

The ECU 60 changes a condition of the exhaust throttle valve 33 between an opening condition and a closed condition by controlling an operation of the actuator 34 based on the cooling water temperature TW and the acceleration displacement amount AR An exhaust purification apparatus 70 of the present embodiment is configured by the exhaust purification catalytic agent 31, a floor temperature sensor 53, the exhaust throttle valve 33, the actuator 34, and the ECU 60.

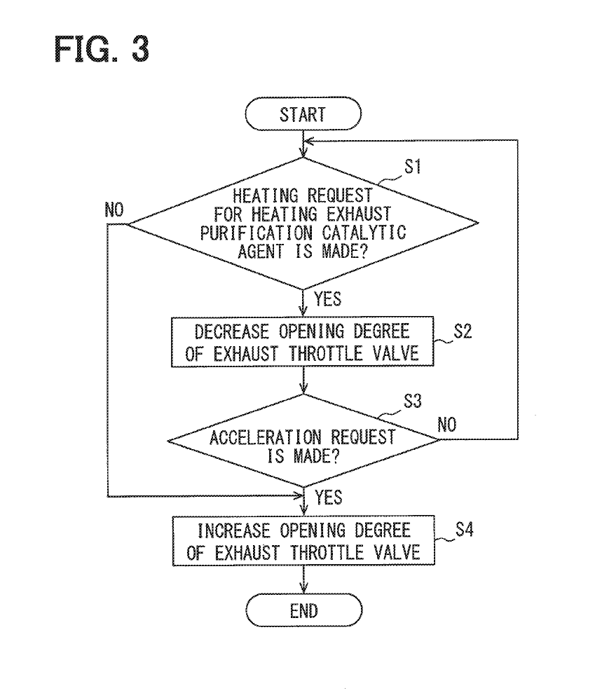

A control for opening and closing the exhaust throttle valve 33 operated by the ECU 60 will be described hereafter referring to FIG, 3. The ECU 60 performs a proceeding shown in FIG. 3 in a specified period. The exhaust throttle valve 33 is in the opening condition when the proceeding shown in FIG. 3 starts.

As shown in FIG. 3, the ECU 60 determines whether a heating request for heating the exhaust purification catalytic agent 31 is made (at S1). For example, the ECU 60 determines whether the cooling water temperature TW is lower than or equal to a water temperature threshold TWth when the internal combustion engine 1 starts to operate, and determines that a cooling operation cooling the internal combustion engine 1 is being performed when the cooling water temperature TW is lower than or equal to the water temperature threshold TWth. The water temperature threshold TWth is set in advance, e.g., based on experimental results, such that it can be determined whether a temperature of the internal combustion engine 1 is a temperature for starting the cooling operation. The ECU 60 determines that the heating request heating for the exhaust purification catalytic agent 31 is made when the cooling operation cooling the internal combustion engine 1 is being performed (S1: YES). On the other hand, the ECU 60 determines that the heating request for heating the exhaust purification catalytic agent 31 is not made when any one of the following condition (a1) to (a3) is met (S1: NO).

(a1) The cooling water temperature TW is higher than the water temperature threshold TWth.

(a2) A specified time has elapsed since the cooling operation cooling the internal combustion engine 1 is started.

(a3) An integrated value of the intake air volume GA from starting the cooling operation cooling the internal combustion engine 1 is higher than a specified volume.

The ECU 60 keeps the exhaust throttle valve 33 to be in the opening condition (at S4) when the heating request for heating the exhaust purification catalytic agent 31 is not made (S1: NO).

The ECU 60 decreases an opening degree of the exhaust throttle valve 33 (at S2) when the heating request for heating the exhaust purification catalytic agent 31 is made (S1: YES). Then, the ECU 60 determines whether an acceleration request is made (at S3). Specifically, the ECU 60 determines that the acceleration request is made (S3: YES) when the acceleration displacement amount AP is greater than or equal to a specified threshold APth. The ECU 60 returns to a determination process of S2 when it is determined that the acceleration request is not made (S3: NO). Accordingly, the exhaust throttle valve 33 is kept in the closing condition when the heating request for heating the exhaust purification catalytic agent 31 is made (S1: YES) and when the acceleration request is not made (S3: NO).

The ECU 60 changes a condition of the exhaust throttle valve 33 from the closing condition to the opening condition (at S4) when the heating request for heating the exhaust purification catalytic agent 31 is not made (S1: NO) or when the acceleration request is made (S3: YES) while the exhaust throttle valve 33 is in the closing condition.

An example of an operation of the exhaust purification apparatus 70 of the present embodiment will be described hereafter.

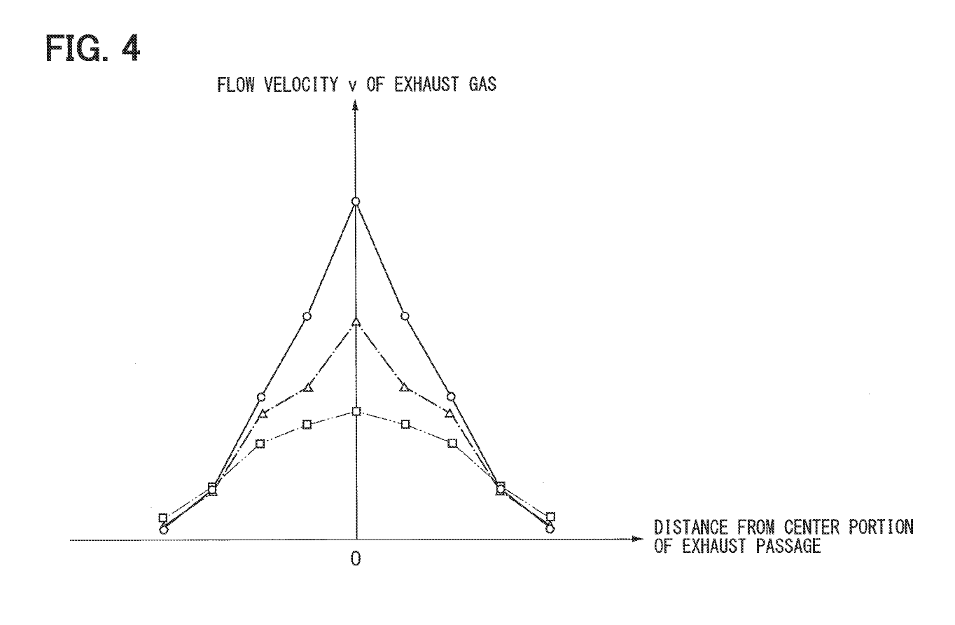

The ECU 60 operates the exhaust throttle valve 33 to be in the closing condition shown in FIG. 2 when the heating request for heating the exhaust purification catalytic agent 31 is made. Accordingly, most of the exhaust gas flows in the center portion of the exhaust passage 30. FIG. 4 shows a flow velocity distribution of the exhaust gas. A two-dot chain line shows the flow velocity distribution without the exhaust throttle valve 33. A one-dot chain line shows the flow velocity distribution when the exhaust throttle valve 33 decreases the passage sectional area of the exhaust passage 30 to have a diameter A. A solid line shows the flow velocity distribution when the exhaust throttle valve 33 decreases the passage sectional area of the exhaust passage 30 to have a diameter B that is smaller than the diameter A. In FIG. 4, a horizontal axis shows a distance from the center portion of the exhaust passage 30 shown in FIG. 1 in a radial direction, and a vertical axis shows a flow velocity v of the exhaust gas.

As shown in FIG. 4, the flow velocity v of the exhaust gas is the fastest in the center portion of the exhaust passage 30 and slows toward an outer periphery of the exhaust passage 30 regardless of a presence or absence of the exhaust throttle valve 33. The flow velocity v of the exhaust gas in the center portion of the exhaust passage 30 becomes faster in a case that the exhaust throttle valve 33 decreases the passage sectional area of the exhaust passage 30 as compared to a case that the exhaust throttle valve 33 is omitted. Moreover, the flow velocity v of the exhaust gas becomes faster as the passage sectional area of the exhaust passage 30 decreases. Thus, it is found that the flow velocity v of the exhaust gas can be increased in the center portion of the exhaust passage 30 in a manner that the exhaust throttle valve 33 is set to be in the closing condition so as to decrease the passage sectional area of the exhaust passage 30. A temperature of the exhaust purification catalytic agent 31 can be increased more promptly by increasing the flow velocity v of the exhaust gas in the center portion of the exhaust passage 30, as compared to the case that the exhaust throttle valve 33 is omitted.

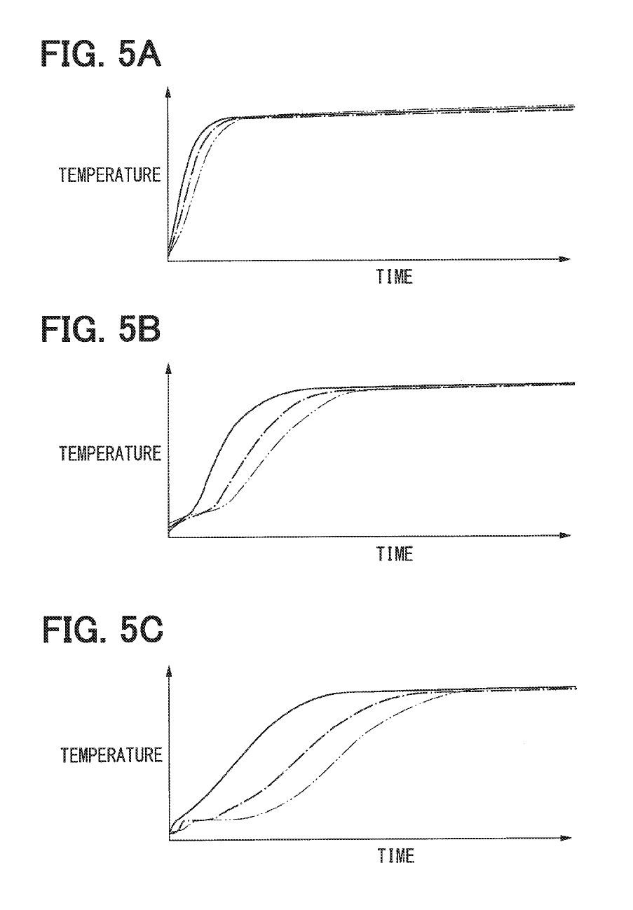

FIG. 5A to FIG. 5C show variations of the temperature of the exhaust purification catalytic agent 31 at positions P10 to P12 shown in FIG. 2. A two-dot chain line shows the variations in the case that the exhaust throttle valve 33 is omitted. A one-dot chain line shows the variations in the case that the exhaust throttle valve 33 decreases the passage sectional area of the exhaust passage 30 to have the diameter A. A solid line shows the variations in the case that the exhaust throttle valve 33 decreases the passage sectional area of the exhaust passage 30 to have the diameter B that is smaller than the diameter A. As shown in FIG. 2, the positions P10 to P12 are located on a central axis ml of the exhaust purification catalytic agent 31. The position P10 is a position of an end surface 310 of the exhaust purification catalytic agent 31 on an exhaust inlet side. The position P11 is a position of a center of the exhaust purification catalytic agent 31. The position P12 is a position of an end surface 311 of the exhaust purification catalytic agent 31 on an exhaust outlet side.

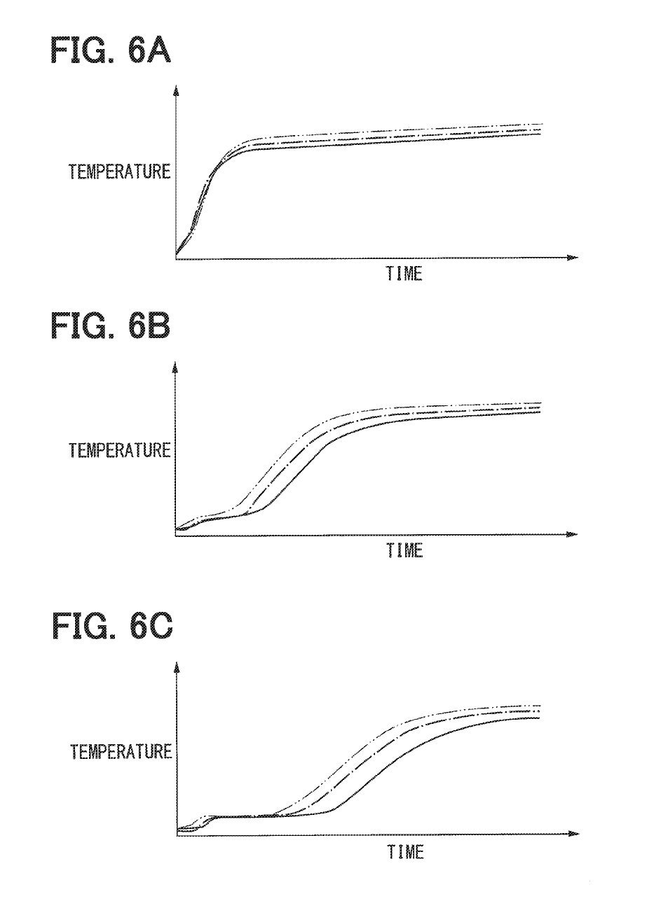

FIG. 6A to FIG. 6C show variations of the temperature of the exhaust purification catalytic agent 31 at positions P20 to P22 shown in FIG. 2. A two-dot chain line shows the variations in the case that the exhaust throttle valve 33 is omitted. A one-dot chain line shows the variations in the case that the exhaust throttle valve 33 decreases the passage sectional area of the exhaust passage 30 to have the diameter A. A solid line shows the variations in the case that the exhaust throttle valve 33 decreases the passage sectional area of the exhaust passage 30 to have the diameter B that is smaller than the diameter A. As shown in FIG. 2, the positions P20 to P22 are located on a line m2 extending along the outer periphery of the exhaust purification catalytic agent 31. The position P20 is a position of the end surface 310 of the exhaust purification catalytic agent 31 on the exhaust inlet side. The position P21 is a position of a center of the exhaust purification catalytic agent 31. The position P22 is a position of the end surface 311 of the exhaust purification catalytic agent 31 on the exhaust outlet side.

As shown in FIG. 5A to FIG. 5C, the temperature of the exhaust purification catalytic agent 31 along the central axis ml increases more promptly in the case that the exhaust throttle valve 33 decreases the passage sectional area of the exhaust passage 30 as compared to the case that the exhaust throttle valve 33 is omitted. In addition, the temperature of the exhaust purification catalytic agent 31 increases more promptly as the passage sectional area of the exhaust passage 30 decreases. Therefore, a portion of the exhaust purification catalytic agent 31 along the central axis ml can be activated locally when a heating operation for heating the internal combustion engine 1, in which the exhaust throttle valve 33 is set to be in the closing condition, is requested. On this occasion, most of the exhaust gas flows in the portion of the exhaust purification catalytic agent 31 along the central axis m1, thereby a reduction effect reducing emissions can be secured.

On the other hand, as shown in FIG. 6A to FIG. 6C, the temperature of the outer periphery of the exhaust purification catalytic agent 31 increases hardly in the case that the exhaust throttle valve 33 decreases the passage sectional area of the exhaust passage 30 as compared to the case that the exhaust throttle valve 33 is omitted. In addition, the temperature of the outer periphery of the exhaust purification catalytic agent 31 increases harder as the passage sectional area of the exhaust passage 30 decreases. As a result, the reduction effect reducing the emissions deteriorates in the outer periphery of the exhaust purification catalytic agent 31. However, a flow rate of the exhaust gas flowing in the outer periphery of the exhaust purification catalytic agent 31 is small since most of the exhaust gas flows in the portion of the exhaust purification catalytic agent 31 along the central axis m1. Therefore, even when the reduction effect reducing the emissions deteriorates in the outer periphery of the exhaust purification catalytic agent 31, the deterioration have less affect, and the reduction effect reducing the emissions in the portion of the exhaust purification catalytic agent 31 along the central axis m1 can have a predominantly greater affect. Moreover, the temperature of the outer periphery of the exhaust purification catalytic agent 31 increases as time elapses as shown in FIG. 6A to FIG. 6C, since reaction heat generated by a catalytic reaction of the exhaust purification catalytic agent 31 in the portion along the central axis m1 transmits to the outer periphery of the exhaust purification catalytic agent 31. As a result, the temperature of the outer periphery of the exhaust purification catalytic agent 31 reaches the activation temperature.

According to the exhaust purification apparatus 70 of the above-described embodiment, the following operations and effects (1) through (5) can be obtained.

(1) The portion of the exhaust purification catalytic agent 31 along the central axis m1 can be activated more promptly when the heating request for heating the exhaust purification catalytic agent 31 is made. In addition, the reduction effect reducing the emissions can be secured since most of the exhaust gas flows in the portion of the exhaust purification catalytic agent 31 along the central axis m1 after the portion is activated.

(2) The ECU 60 determines the heating request for heating the exhaust purification catalytic agent 31 is made when the cooling operation cooling the internal combustion engine 1 is being performed, and decreases the opening degree of the exhaust throttle valve 33. Accordingly, a time required for activating the exhaust purification catalytic agent 31 can be shortened, specifically when the cooling operation cooling the internal combustion engine 1, in which the exhaust purification catalytic agent 31 is needed to be activated promptly, is being performed. Thus, the reduction effect reducing the emissions can be excellent.

(3) When a driver operates the accelerator to accelerate the vehicle while the exhaust throttle valve 33 is in the closing condition, an exhaust pressure increases excessively, and an output power of the internal combustion engine 1 may deteriorate. According to the exhaust purification apparatus 70 of the present embodiment, the ECU 60 determines that the acceleration request is made and changes the condition of the exhaust throttle valve 33 from the closing condition to the opening condition when the driver operates the accelerator to accelerate the vehicle. Therefore, the deterioration of the output power from the internal combustion engine 1 due to an excess increase of the exhaust pressure can be suppressed. As a result, a deterioration of drivability can be suppressed.

(4) The exhaust throttle valve 33 defines the single throttle passage in the exhaust passage 30 when being in the closing condition. Specifically, the exhaust throttle valve 33 defines the single throttle path in the center area of the exhaust passage. Accordingly, the flow velocity of the exhaust gas increases, thereby the temperature of the exhaust purification catalytic agent 31 can be increased more promptly as compared to a case that more than one throttle path are defined. That is, a time required for activating the exhaust purification catalytic agent 31 can be further shortened, and thereby the reduction effect reducing the emissions can be obtained accurately.

(5) The exhaust throttle valve 33 is arranged adjacent to the exhaust inlet port 352 of the case 35. Accordingly, the exhaust gas of which flow velocity is increased by the exhaust throttle valve 33 can reach the exhaust purification catalytic agent 31 easily, and thereby the portion of the exhaust purification catalytic agent 31 along the central axis ml can be activated easily.

(Other Modifications)

While the present disclosure has been described with reference to preferred embodiments thereof, it is to be understood that the disclosure is not limited to the preferred embodiments and constructions. The present disclosure is intended to cover various modification and equivalent arrangements within a scope of the present disclosure.

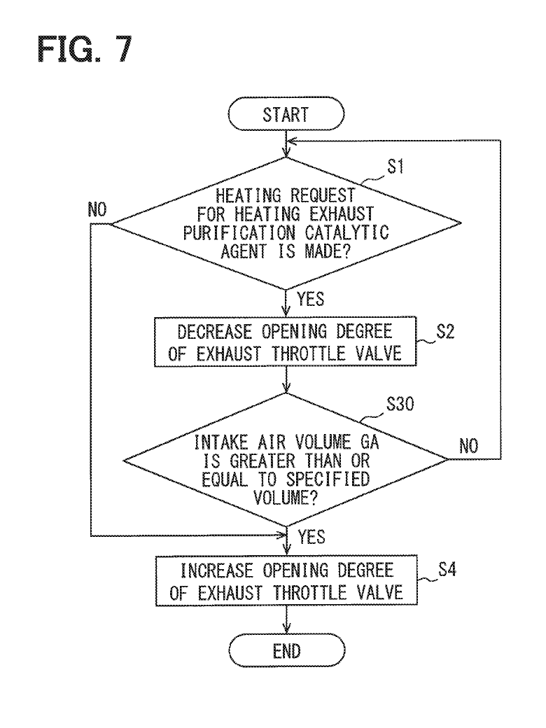

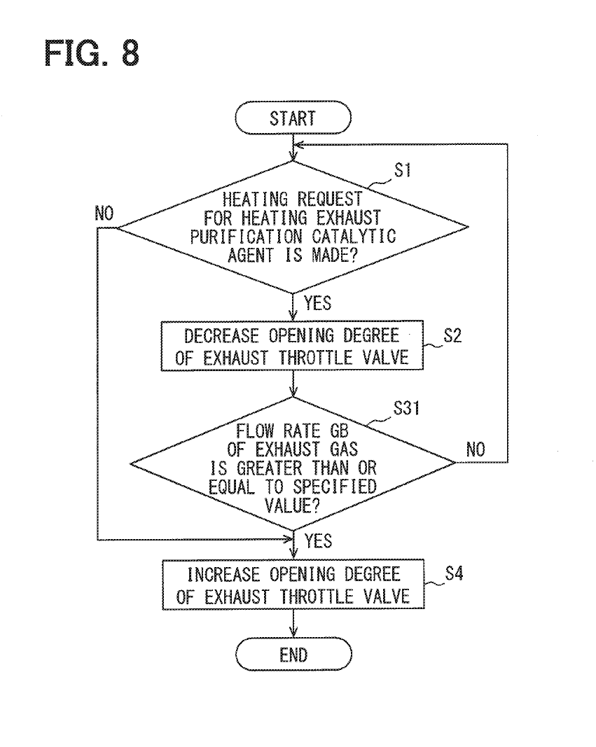

As shown in FIG. 7, the ECU 60 may determine whether the intake air volume GA detected by the intake air volume sensor 50 is greater than or equal to a specified volume (at S30), instead of the process of S3 shown in FIG. 3. Alternatively, as shown in FIG. 1, an exhaust flow rate sensor 36 that detects a flow rate GB of the exhaust gas may be disposed in the exhaust passage 30. As shown in FIG. 8, the ECU 60 may determine whether the flow rate GB of the exhaust gas detected by the exhaust flow rate sensor 36 is greater than or equal to a specified value (at S31), instead of the process of S3 shown in FIG. 3. The intake air volume GA or the flow rate GB of the exhaust gas is increased when the driver operates the accelerator to accelerate the vehicle. That is, according to both the processing shown in FIG. 7 and the processing shown in FIG. 8, the condition of the exhaust throttle valve 33 is changed from the closing condition to the opening condition when the driver operates the accelerator to accelerate the vehicle. Therefore, the same operations and effects as the above-described operations and effects (3) can be obtained.

A determination process at S1 in FIG. 3 for determining whether the heating request for heating the exhaust purification catalytic agent 31 is made can be modified as required. For example, as shown in FIG. 1, an exhaust temperature sensor 57 that detects an exhaust temperature TO of the exhaust gas after passing through the exhaust purification catalytic agent 31 may be disposed in the exhaust passage 30. Then, the ECU 60 may determine that the heating request for heating the exhaust purification catalytic agent 31 is made when the exhaust temperature TO that is detected by the exhaust temperature sensor 57 is lower than a specified temperature. Alternatively, the ECU 60 may calculate an estimated temperature of the exhaust purification catalytic agent 31 based on a variation of the exhaust temperature TO detected by the exhaust temperature sensor 57, and may determine that the heating request for heating the exhaust purification catalytic agent 31 is made when the estimated temperature is lower than a specified temperature.

The exhaust throttle valve 33 is not limited to be arranged adjacent to the exhaust inlet port 352 of the case 35. However, a position of the exhaust throttle valve 33 can be changed as required as long as the exhaust throttle valve 33 is located upstream of the exhaust purification catalytic agent 31.

The exhaust throttle valve 33 may define more than one throttle path in the exhaust passage 30 when being in the closing condition. Alternatively, the exhaust throttle valve 33 may define the throttle path outside the center area of the exhaust passage 30 when being in the closing condition.

However, the present disclosure is not limited to the above-described specific examples. That is, modifications that are made by a person having ordinary skill in the art, as required, based on the specific examples are included in a range of the present disclosure as long as having the features of the present disclosure. For example, elements mentioned in the specific examples, an arrangement, a material, a condition, a shape, a size, etc. of the elements are not limited to the specific examples, and can be changed as required. Elements mentioned in the above-described embodiments can be combined as long as it is technically possible, and the combination is included in the range of the present disclosure as long as having the features of the above-described embodiments.

1. An exhaust purification apparatus for an internal combustion engine, the exhaust purification apparatus having an exhaust purification catalytic agent disposed in an exhaust passage, the exhaust purification apparatus comprising:
an exhaust throttle valve that is arranged upstream of the exhaust purification catalytic agent in the exhaust passage and changes a passage sectional area of the exhaust passage;
an actuator that operates the exhaust throttle valve to be open and closed; and
a controller that controls the exhaust throttle valve to be open and closed through the actuator, wherein
the controller decreases an opening degree of the exhaust throttle valve to narrow the passage sectional area of the exhaust passage upon a heating request for heating the exhaust purification catalytic agent.

2. The exhaust purification apparatus for the internal combustion engine according to claim 1, wherein
the controller determines that the heating request is made when a cooling operation cooling the internal combustion engine is being performed.

3. The exhaust purification apparatus for the internal combustion engine according to claim 1, wherein
the controller determines that the heating request is made when an estimated temperature of the exhaust purification catalytic agent is lower than a specified temperature.

4. The exhaust purification apparatus for the internal combustion engine according to claim 1, wherein
the controller determines that the heating request is made when a temperature of exhaust gas after passing through the exhaust purification catalytic agent is lower than a specified temperature.

5. The exhaust purification apparatus for the internal combustion engine according to claim 1, wherein
the controller changes a condition of the exhaust throttle valve from a closed condition to an opening condition when an accelerator is operated to accelerate a vehicle.

6. The exhaust purification apparatus for the internal combustion engine according to claim 1, further comprising
an intake air volume sensor that detects a volume of intake air drawn into the internal combustion engine, wherein
the controller changes a condition of the exhaust throttle valve from a closed condition to an opening condition when the volume of the intake air detected by the intake air volume sensor becomes greater than or equal to a specified volume.

7. The exhaust purification apparatus for the internal combustion engine according to claim 1, further comprising an exhaust flow rate sensor that detects a flow rate of exhaust gas flowing in the exhaust passage, wherein
the controller changes a condition of the exhaust throttle valve from a closed condition to an opening condition when the flow rate of the exhaust gas detected by the exhaust flow rate sensor becomes greater than or equal to a specified value.

8. The exhaust purification apparatus for the internal combustion engine according to claim 1, wherein
the exhaust throttle valve defines a single throttle path in the exhaust passage when being in the closed condition.

9. The exhaust purification apparatus for the internal combustion engine according to claim 8, wherein
the exhaust throttle valve defines the single throttle path in a center area of the exhaust passage when being in the closed condition.

10. The exhaust purification apparatus for the internal combustion engine according to claim 1, further comprising
a case that surrounds the exhaust purification catalytic agent, wherein
the exhaust throttle valve is located adjacent to an exhaust inlet port that is an inlet of the case located upstream of the exhaust purification catalytic agent.
